(19) United States
(12) Patent Application Publication
(10) Pub. No.: US 2006/0041459 A1
(43) Pub. Date: Feb. 23, 2006

(54) System, method and computer program product for total effective cost management

(75) Inventors: David M. Hester, St. Louis, MO (US); Scott R. Greene, Defiance, MO (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: The Boeing Company, Chicago, IL (US)

(21) Appl. No.: 10/921,588

(22) Filed: Aug. 18, 2004

(51) Int. Cl. G06F 9/46

(52) U.S. Cl. 705/8

(57) ABSTRACT

A method for total effective cost management in an organization includes creating a maintenance plan for the organization, the maintenance plan including at least one task performed during maintenance of the organization. Then, a plurality of different maintenance schedules are created for performing the task(s) of the maintenance plan. A total effective cost (TEC) associated with each maintenance schedule is then determined based upon a cost and an availability associated with the maintenance schedule, the availability being based upon a down time and a mission time associated with the maintenance schedule. Thereafter, a maintenance schedule is selected from the plurality of different maintenance schedules based upon the TEC for each maintenance schedule.

### FIELD OF THE INVENTION

The present invention relates to systems and methods for managing resources in performing tasks and, more particularly, relates to systems, methods and computer program products for appraising system performance for maintenance plans to thereby manage resources in performing such maintenance plans.

### BACKGROUND OF THE INVENTION

In many industries, planning for equipment and product maintenance currently involves the manual collection of data from a number of disparate sources and requires the analysis of the maintenance requirements of the equipment and/or product by those with relevant knowledge of the equipment and/or product to thereby identify resource requirements and schedule maintenance at a high level within an enterprise. Most of the data sources for maintenance planning exist in paper form and some are semi-automated. During times of high tempo operations, however, little or no time exists for the orderly collection and evaluation of problem data and the planning process becomes a response to individual equipment/product needs for its immediate use.

As will be appreciated, operations and support activities of an organization typically comprise sixty percent or more of the life cycle costs of systems such as aerospace vehicles. Thus, a common goal of support planning is generally to lower the costs of operations and support. Optimizing support planning by reducing the costs of operations and support, however, can result in diminishing system availability. Diminishing system availability, in turn, can lead to a loss in the potential value of the system. As such, it would be desirable to develop a system and method of optimizing operations and support costs to achieve a required availability of a system, while lowering the total cost of ownership of the system.

### SUMMARY OF THE INVENTION

In light of the foregoing background, embodiments of the present invention provide systems, methods and computer program products for managing the total effective cost of maintenance schedules, each including groups of one or more tasks of a maintenance plan, to thereby permit selection of the most cost-effective maintenance schedule. More particularly, embodiments of the present invention provide a unique technique for appraising both actual and planned system performance to thereby enable selection of maintenance schedules to optimize ownership costs of maintained hosts, systems, subsystems, components and the like. To facilitate selecting a maintenance schedule for performing the tasks of maintenance plans, embodiments of the present invention provide a total effective cost (TEC) figure of merit associated with each of a number of alternative maintenance schedules.

The TEC figure of merit clarifies the solution space for the selection of alternative maintenance schedules by delineating schedules that lower ownership cost from schedules that raise ownership cost. Further, the TEC figure of merit facilitates selecting schedules with an emphasis on availability of the maintained organization or complex system during periods of high demand. And during periods of low demand, the TEC figure of merit facilitates selecting schedules with an emphasis on spending.

According to one aspect of the present invention, a method is provided for total effective cost management in an organization. The method includes creating a maintenance plan for the organization, the maintenance plan including at least one task performed during maintenance of the organization. More particularly, for example, the maintenance plan can be created with task(s) having an associated time duration, such as an associated mean time duration, expected to complete the respective task, and/or cost expected to be incurred in performing the respective task. In such instances, the method can further include determining a down time associated with each of the plurality of different maintenance schedules based upon the time duration expected to complete at least one task of the maintenance plan. Additionally or alternatively, a cost associated with each of the plurality of different maintenance schedules can be determined based upon a cost expected to be incurred in performing at least one task of the maintenance plan.

After creating the maintenance plan, a plurality of different maintenance schedules can be created for performing the task(s) of the maintenance plan. Then, a total effective cost (TEC) associated with each maintenance schedule can be determined based upon a cost and an availability associated with the maintenance schedule, the availability being based upon a down time and a mission time associated with the maintenance schedule. For example, the TEC associated with each maintenance schedule comprises can be determined in accordance with the following:

$$TEC = Cost \times ( 1 + \frac{MDT}{MMT} )$$

In the preceding, Cost represents a cost associated with the maintenance schedule, and MDT and MMT represent a down time and mission time, respectively, associated with the maintenance schedule. Then, after determining the TEC associated with each maintenance plan, a maintenance schedule is selected from the plurality of different maintenance schedules based upon the TEC for each maintenance schedule, such as by selecting the maintenance schedule associated with the lowest TEC.

In one typical scenario, the organization can comprise a hierarchical organization including n levels L₁ . . . Lₙ with n being a positive integer. For at least i>1, then, each level Lᵢ can comprise a plurality of components, with the components of level Lᵢ₋₁ comprising groupings of the components of level Lᵢ. In such instances, a maintenance plan and plurality of different maintenance schedules can be created, a TEC associated with each maintenance schedule can be determined, and a maintenance schedule can be selected for at least one component of at least one level of the organization.

Also in such instances, a down time associated with each of the plurality of different maintenance schedules of at least one component of at least one level can be determined based upon the time duration expected to complete at least one task of the maintenance plan of the respective component of the respective level. Similarly, a cost associated with each of the plurality of different maintenance schedules of at least one component of at least one level can be determined based upon a cost expected to be incurred in performing at least one task of the maintenance plan of the respective component of the respective level. More particularly for at least level Lᵢ₊₁, the down time and cost associated with each of the plurality of different maintenance schedules of at least one component of level Lᵢ₊₁ can be determined based upon the down time and cost associated with at least one component of level Lᵢ grouped to form the component of level Lᵢ₊₁.

According to other aspects of the present invention, a system and computer program product are provided for total effective cost management in an organization.

### BRIEF DESCRIPTION OF THE DRAWINGS

Having thus described the invention in general terms, reference will now be made to the accompanying drawings, which are not necessarily drawn to scale, and wherein:

FIG. 1 is a schematic diagram illustrating a hierarchical organization that would benefit from one embodiment of the present invention;

FIG. 2 is a time line illustrating the availability of a complex system of one embodiment of the present invention, the availability being determined based upon an “up” time duration of the complex system and a “down” time duration of the complex system;

FIG. 3 is a flowchart illustrating various steps in a method of total effective cost management in an organization;

FIG. 4 illustrates an example maintenance plan created in accordance with one embodiment of the present invention;

FIGS. 5A, 5B and 5C are example maintenance schedules created in accordance with one embodiment of the present invention; and

FIG. 6 is a schematic block diagram of the system of one embodiment of the present invention embodied by a computer system.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

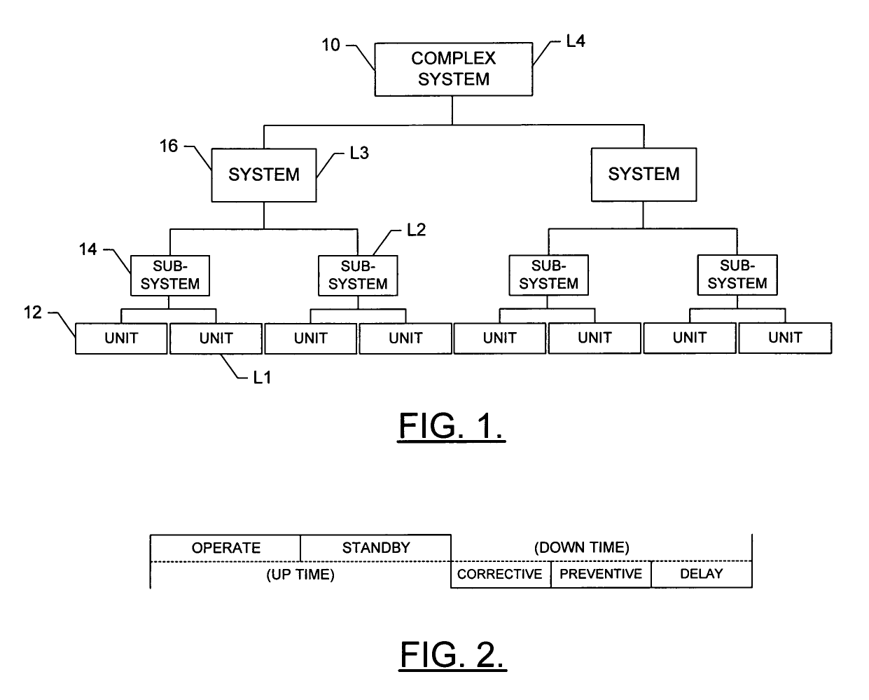

Referring to FIG. 1, a complex system 10 that would benefit from the system and method of the present invention is illustrated. The system consists of n levels L₁ . . . Lₙ, with n being a positive integer. In the complex system, each level above the first level generally comprises a plurality of components, with the components of the level being groups of the components of the level below. For example, the system illustrated in FIG. 1 consists of four levels, L₁ . . . L₄. As illustrated, the level 4 complex system includes units 12 at level L₁, subsystems 14 at level L₂ and systems 16 at level L₃. The systems at level L₃ are groups of the respective subsystems at level L₂. And the subsystems at level L₂ are groups of the units at level L₁. In the military, for example, the fourth level might comprise an aircraft, with the third, second and first levels comprising systems, subsystems and components of the respective aircraft. As evident, the number of levels in the complex system depends upon the complex system. Therefore, it should be understood that the systems, methods and computer program products of the present invention can be employed by complex systems with any of a number of levels.

As will be appreciated, the total ownership cost (TOC) of a complex system 10 can be defined as the loss or cost to society of a complex system program including costs associated with system acquisition and retirement, life cycle operations and support (O&S), and unavailability and unsuccessful operation. In notational terms, the TOC of a complex system can be defined as follows:

$$TOC ( \$ ) = \frac{Acquistion Cost + O \& S Cost}{Availability \times Probability of Operation Su ccess} + Retirement Cost$$

For more information on the TOC of a complex system, see Philip T. Frohne, QUANTITATIVE MEASURES OF LOGISTICS (2002).

As will also be appreciated, in the operation phase of the life cycle of a complex system 10, acquisition costs are typically sunk, particularly when capacity planning and capital budgeting are performed discretely and separately from daily activity planning. Also, performing maintenance required by engineering can often result in a probability of operation success that approaches unity. In addition, during the operation phase of the life cycle of the complex systems, retirement costs are typically beyond the planning horizon. Thus, disregarding the acquisition and retirement costs, and equating the probability of operation success to unity, the TOC of a complex system can be reduced to the following total effective cost (TEC) figure of merit:

$$TEC ( \$ ) = \frac{O \& S Cost}{Availability} \qquad ( 1 )$$

In general, the TEC of a complex system 10 applies for general day-to-day maintenance planning, where the goal is to maintain a designed probability of operation success by performing maintenance and support tasks deemed operation critical by engineering. In this regard, the TEC considers system acquisition costs for system design, capacity planning and capital budgeting. Once outlaid, however, the capital is considered sunk, and the depreciation burden becomes an operational overhead expense.

The total overhead expense can be part of the O&S cost structure. Typically, the costs of O&S tasks can be identifiable to the material, labor and overhead associated with each task. Task costs can be easily aggregated to compare the cost of one schedule implementing a maintenance plan to another schedule for the same maintenance plan. As such, cost management has been at the forefront of enterprise resource planning. Unfortunately, however, measuring and managing availability of a complex system 10 has not been as well developed.

Thus, in accordance with embodiments of the present invention, to account for availability of maintenance schedules related to a complex system 10, availability in the management of the TEC can be represented as a measure of time duration. More particularly, as shown in FIG. 2, the availability of a complex system can be measured based upon an “up” time duration of the complex system and a “down” time duration of the complex system. As shown, the up time duration includes both the time duration the complex system is in operation, and the time duration the complex system is available but not otherwise operating (standby). As also shown, the down time duration includes time durations associated with corrective maintenance and preventative maintenance, and time delays. In notational terms, the availability of a complex system can be defined as follows:

$$Availability = \frac{Up Time}{Up Time + Down Time} = \frac{MMT + MST}{MMT + MST + MDT} ,$$

where MMT represents the mean mission, or operation, time of the complex system, MST represents the mean standby time, and MDT represents the mean down time of the complex system. As explained herein, the time parameters associated with the complex system may be referred to as mean times. It should be understood, however, that the time parameters may more generally be expected times (e.g., expected mission time, expected down time, etc.). The mean times, then, can be representative of the expected times. Irrespective of the representation of the expected times, however, it can be shown that the availability of the complex system can be represented as a percentage of time the complex system is available during a given operation cycle (i.e., up time plus down time) of the complex system.

As will be appreciated, in many complex system programs, the complex system 10 can be considered a continuous use system. In such complex system programs, the complex system can be considered to be always, or almost always, in operation. Thus, in such complex system programs, the system has a standby time duration that approaches zero (MST=0). Thus, for a continuous use complex system, the availability can be rewritten as follows:

$$Availability = \frac{MMT}{MMT + MDT} \qquad ( 2 )$$

Substituting the availability measure of equation (2) with the TEC figure of merit of equation (1), then, yields the following equation (3):

$$TEC ( \$ ) = \frac{O \& S Cost}{\frac{MMT}{MMT + MDT}} = O \& S Cost \times ( 1 + \frac{MDT}{MMT} ) \qquad ( 3 )$$

As shown, the TEC for a complex system can be based upon the costs associated with life cycle operations and support (O&S Cost), the mean mission time duration (MMT) of the complex system and the mean down time duration (MDT) of the complex system. Thus, as explained below, the TEC can factor spending by an effective available time duration ratio to optimize both the cost and throughput of the complex system.

In accordance with embodiments of the present invention, a method of TEC management can be employed at each level of the complex system 10 to thereby optimize the TEC, and thus the O&S cost and availability, of the respective level, and improve the TEC(s), and thus the O&S cost(s) and availabilit(ies), of the levels above the respective level. For example, the method of TEC management can be employed to optimize the TEC (O&S cost and availability) of each unit 12 at the unit level. By optimizing the TEC of each unit, the method of TEC management necessarily improves the TEC(s) (O&S cost(s) and availability(ies)) of the subsystem 14 including the respective units, the system 16 including the respective subsystem, and thus the complex system.

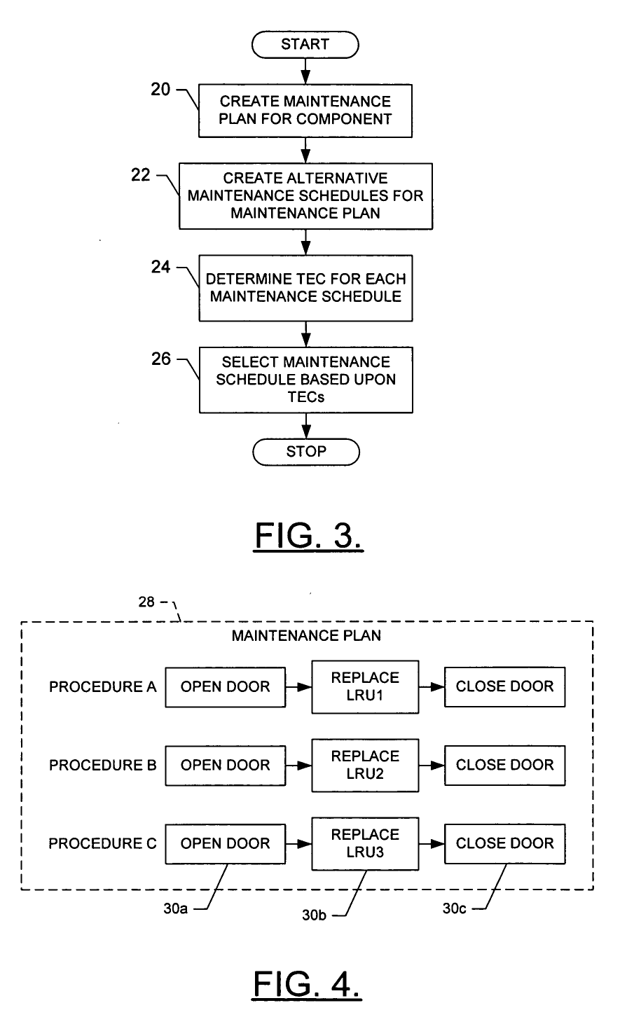

Reference is now made to FIG. 3, which illustrates various steps in a method of TEC management. The method will be described in terms of TEC management of a unit 12 component of a complex system 10. It should be understood, however, that the method can equally be applied to other components (e.g., subsystems 14, systems 16, complex system) of the complex system without departing from the spirit and scope of the present invention. As shown, a method of TEC management for a given unit of a complex system includes creating a maintenance plan for the unit, as shown in block 20. In this regard, the maintenance plan can be created to include one or more tasks in the maintenance of the unit. In this regard, the maintenance plan typically includes at least one task, where each task has an associated mean time duration expected to complete the respective task. As will be appreciated by those skilled in the art, the mean time duration associated with each task of the maintenance plan can be determined in any of a number of different manners, such as from historical data, estimations, projections or the like. As explained below, the mean down time (MDT) of the unit being maintained can be determined based upon mean time duration of tasks of the maintenance plan.

Also, each task of the maintenance plan typically has an associated cost, such as an O&S cost, expected to be incurred in performing the respective task. Like the associated mean time duration, the O&S cost associated with each task can be determined in any of a number of different manners. For example, the O&S cost can be determined from historical data, estimations, projections or the like. In this regard, as indicated above, the O&S cost of each task of the maintenance plan can be determined from the aggregate of costs associated with material, labor and overhead related to performing the task.

Irrespective of how the maintenance plan is created, a plurality of alternative schedules for performing the tasks of the maintenance plan can thereafter be created, as shown in block 22. Each maintenance schedule can be created in any of a number of different manners to schedule at least one resource to act on the tasks to thereby perform the tasks and complete the maintenance plan. For example, consider the graphical illustration of the exemplar maintenance plan 28 for a unit 12 (see FIG. 1) of an aircraft (i.e., complex system 10) shown in FIG. 4. As shown, the maintenance plan includes three procedures, namely procedures A, B and C, each of which includes three tasks 30a, 30b and 30c. Procedure A includes the tasks of opening a door of the aircraft, replacing a first LRU (i.e., LRU1), and thereafter closing the door. Similarly, procedure B includes the tasks of opening the door, replacing a second LRU (i.e., LRU2), and closing the door; and procedure C includes opening the door, replacing a third LRU (i.e., LRU3), and closing the door.

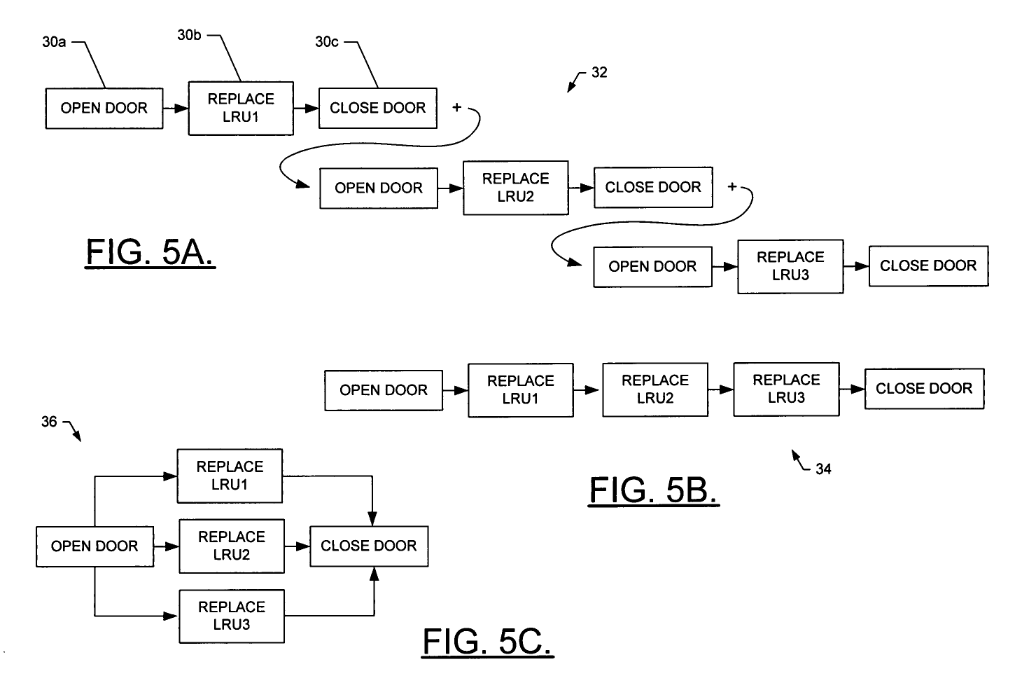

From the maintenance plan 28 shown in FIG. 4, a number of different maintenance schedules can be created. As shown in FIG. 5A, for example, a serial schedule 32 can be created that includes performing each procedure in succession. Alternatively, as shown in FIG. 5B, a combined, resource-constrained schedule 34 can be created that includes first opening the aircraft door (task 30a), which is common to all of the procedures. Then, the schedule includes replacing each LRU (task 30b) in succession, and ends with closing the door (task 30c), which is also common to all of the procedures. In yet another alternative, as shown in FIG. 5C, a combined, resource-unconstrained schedule 36 can be created that, like the resource-constrained schedule of FIG. 5B, includes first opening the aircraft door, which is common to all of the procedures. Thereafter, unlike the resource-constrained schedule, the resource-unconstrained schedule includes replacing all of the LRUs in parallel. Then, again like the resource-constrained schedule, the resource-unconstrained schedule ends with closing the door, which is also common to all of the procedures.

Irrespective of how the maintenance schedules are created, after creating the maintenance schedules, a TEC for the unit 12 with respect to each maintenance schedule can be determined, as shown in block 24. More particularly the TEC for the unit with respect to each maintenance schedule can be determined based upon the O&S cost and mean down time (MDT) of the unit with respect to each maintenance schedule, and a mean mission time (MMT) of the unit, such as in accordance with equation (2) above. In this regard, the O&S cost of the unit with respect to each maintenance schedule can be determined by summing the O&S cost associated with each task of the respective maintenance schedule.

For example, consider that each task of the maintenance plan of FIG. 4, and thus the maintenance schedules of FIGS. 5A-5C, have an associated O&S cost of ten dollars. In such an instance, because the tasks of the serial schedule 32 of FIG. 5A occur in succession with no overlap, the O&S cost of the unit 12 with respect to the serial schedule can be determined by summing the O&S cost associated with each task of each procedure of the respective maintenance plan for a total of ninety dollars (i.e., $10×9). In contrast, for the resource-constrained schedule 34 of FIG. 5B, since the door opening and closing tasks 26a, 26c are performed once for each procedure, the O&S cost of the unit with respect to the resource-constrained schedule can be determined by summing the time duration associated with opening the door, replacing each of LRU1, LRU2 and LRU3 (task 26b), and closing the door for a total of fifty dollars (i.e., $10×5). Likewise, since the resource-unconstrained schedule 36 of FIG. 5C includes the same number of tasks as the resource-constrained schedule of FIG. 5B, the resource-unconstrained schedule can also have an O&S cost of fifty dollars.

The mean down time of the unit 12 with respect to each maintenance plan can be determined based upon the time duration required to perform all of the tasks of each maintenance schedule. For example, further consider that each task of the maintenance plan of FIG. 4, and thus the maintenance schedules of FIGS. 5A-5C, have an associated time duration of ten minutes. In such an instance, considering the tasks of the serial schedule 32 of FIG. 5A occur in succession with no overlap, the mean down time of the unit with respect to the serial schedule can be determined by summing the time duration associated with each task of each procedure of the respective maintenance plan for a total mean down time of ninety minutes (i.e., 10 minutes×9). In contrast, for the resource-constrained schedule 34 of FIG. 5B, since the door opening and closing tasks 26a, 26c are performed once for each procedure, the mean down time of the unit with respect to the resource-constrained schedule can be determined by summing the time duration associated with opening the door, replacing each of LRU1, LRU2 and LRU3 (task 26b), and closing the door, for a total mean down time of fifty minutes (i.e., 10 minutes×5). Similarly, for the resource-unconstrained schedule 36 of FIG. 5C, since the tasks of replacing the LRUs further occur in parallel, the mean down time of the respective schedule with respect to the resource-unconstrained schedule can be determined by summing the time duration associated with opening the door, the longest duration replacing one of LRU1, LRU2 and LRU3, and closing the door, for a total of thirty minutes (i.e., 10 minutes×3).

After determining the O&S cost and mean down time (i.e., MDT) of the unit 12 with respect to each maintenance schedule, the TEC of the unit with respect to each maintenance schedule can be determined. In this regard, further consider that the unit has a mean mission time of one hour (i.e., 60 minutes). In such an instance, the serial schedule 32 of FIG. 5A can be determined to have a TEC of $135 (i.e., $90×[1+90/60]). Similarly, the resource-constrained schedule 34 of FIG. 5B can be determined to have a TEC of $92 (i.e., $50×[1+50/60]); and the resource-unconstrained schedule 36 of FIG. 5C can be determined to have a TEC of $75 (i.e., $50×[1+30/60]).

Irrespective of how the TEC for the unit 12 with respect to each maintenance schedule is determined, one of the created maintenance schedules can thereafter be selected based upon the determined TECs, as shown in block 26. More particularly, the maintenance schedule with the most optimum TEC can be selected. In this regard, the maintenance plan with the smallest TEC, the maintenance plan with the least total effective cost, is typically selected as the maintenance plan with the most optimum TEC. However, it should be appreciated that in various instances it may be desirable to select another maintenance schedule. For example, in an instance with increasing demand and/or prices for the unit, it may be desirable to select a maintenance schedule with a greater TEC, provided the selected maintenance schedule provides a shorter down time for the unit.

The technique of selecting a maintenance schedule can be performed for each unit 12 of the complex system 10. In this regard, for each unit of the complex system, a maintenance schedule can be selected in the same manner described above. Similarly, for each component (e.g., subsystem 14, system 16, complex system) of each level of the complex system, a maintenance schedule can be selected in the same manner described above. For higher levels of the complex system, such as the levels including subsystems, systems and the complex system itself, however, the O&S cost and down time of each higher-level component can be determined based upon the O&S cost and down time, respectively, of the plurality of lower-level components forming the higher-level component with respect to the selected maintenance schedules for the lower-level components. More particularly, the O&S cost and down time of each higher-level component can be determined by summing the O&S costs and down times, respectively, of the plurality of lower-level components forming the higher-level component with respect to the selected maintenance schedules for the lower-level components. For example, for each level 2 subsystem of the complex system, the O&S cost and down time can be determined by summing the O&S costs and down times, respectively, of the plurality of level 1 units forming the respective subsystem with respect to the selected maintenance schedule for the units.

As will be appreciated, at instantaneous decision points, particularly at the lowest levels of the complex system 10, the base of resource(s) available to act on the tasks to thereby perform the tasks and complete the maintenance plan in accordance with a respective maintenance schedule can be considered fixed. Thus, resource(s) not utilized in performing the tasks of the maintenance plan can be assumed to be available for other tasking, training, future reduction or demand capture, or the like. In various instances, particularly at the higher levels of the complex system, however, it can be advantageous to further consider utilization of resource(s) in performing the tasks of maintenance plans of a complex system to thereby select the most optimum TEC for the respective component of the complex system.

Embodiments of the present invention are therefore capable of capturing resource utilization in complex-system metrics, particularly at higher levels of the complex system. In this regard, embodiments of the present invention are capable of operating in conjunction with a dynamic resource management process such as to manage the resources of an organization to select and schedule maintenance plans that provide the most value. A typical example of implementing an embodiment of the present invention in conjunction with a dynamic resource management process will now be provided. For more information on such a dynamic resource management process, however, see U.S. patent application Ser. No. 09/964,045, entitled: System, Method and Computer Program Product for Dynamic Resource Management, filed Sep. 26, 2001, the contents of which are hereby incorporated by reference in its entirety.

Consider, for example, a launch system with two orbiters and two boosters. A mission consists of a booster lifting an orbiter to space where the orbiter performs various on-orbit missions. To conduct each mission requires a number of different tasks. One or more of the tasks, in turn, can have a cost rate per day (i.e., rate), a number of days to completion (i.e., duration) and a total cost (i.e., cost) and a resource required to perform the task, as shown in Table 1.

TABLE 1
General Mission Tasking

| Task | Rate | Duration | Cost | Required Resource |
|---|---|---|---|---|
| Booster Mission | $110 | 1 | $110 | Booster Controller |
| Booster Processing | $155 | 20 | $3,100 | Booster Maintenance |
| Checkout and | $100 | 3 | $299 | Checkout & Launch, |
| Launch | | | | Test & Control |
| Mate | $88 | 5 | $442 | Mate Assemblers |
| Orbiter Mission | $110 | 10 | $1,100 | Orbiter Controller |
| Orbiter Processing | $155 | 20 | $3,100 | Orbiter Maintenance |
| Standby | $0 | 1 | $0 | None |

Also assume that the complex system only has one of each required resource. Therefore, if the booster maintenance resource is processing booster 1, then the booster maintenance resource cannot process booster 2 until after processing booster 1. Or if the mate assemblers are mating orbiter 1 and booster 1, the mate assemblers cannot mate orbiter 2 and booster 2 until after mating orbiter 1 and booster 1. Further, consider that the rate for each task includes a variable material cost, and fixed labor and overhead costs associated with the resource required to perform the task, as shown in Table 2 below.

TABLE 2
Mission Task Resource Costs

| | Variable | Fixed Costs | | Total |
|---|---|---|---|---|
| Resource | Material Cost | Labor | Overhead | Cost |
| Booster Maintenance | $100 | $15 | $40 | $155 |
| Orbiter Maintenance | $100 | $15 | $40 | $155 |
| Checkout & Launch | $8 | $25 | $67 | $100 |
| Test & Control | | | | |
| Mate Assemblers | $15 | $20 | $53 | $88 |
| Orbiter Controller | $0 | $30 | $80 | $110 |
| Booster Controller | $0 | $30 | $80 | $110 |
| Resource Totals | $223 | $108 | $287 | $718 |

From the costs associated with the resources shown in Table 2, it can be shown that from an annual spending standpoint, the operation outlays $144,174 in fixed labor and overhead (i.e., ($108+$287)/day×365 days). In addition, the variable material cost per mission can be determined by multiplying each variable material rate by the duration of use of the resource in performing a respective task. Thus, the annual variable expense can be determined by multiplying the number of missions by $4,198 material/mission (i.e., 20($100+$100)+6($8)+10($15)).

One of the functions of dynamic resource management is to provide integrated flying, maintenance, and training schedules. This illustration, then, shows how embodiments of the present invention can be implemented to provide a TEC figure of merit, which can be used to select a maintenance and flying plan. In this regard, consider two alternative techniques for planning the turns of the example four element system (i.e., orbiter 1, booster 1, orbiter 2 and booster 2). In the first technique, referred to as O1B1, the turns are planned in accordance with an operational prioritization rule that orbiter 1 and booster 1 have priority such that if either requires a resource for a given task, the respective element receives the resource. In this technique, if orbiter 2 or booster 2 requires the same resource at the same time, orbiter 2 or booster 2 must be delayed until the resource completes the respective task for orbiter 1 or booster 1. Alternatively, in the second technique, referred to as NINO, the next element to require a resource receives the resource. Thus, if orbiter 2 requires a free resource, orbiter 2 receives the resource until the respective task is complete regardless of whether, during performance of the task, orbiter 1 requires the resource.

Applying the O1B1 and NINO techniques for planning the turns of the example four element system, then, it can be shown that, annually, orbiter 1, booster 1, orbiter 2 and booster 2 are capable of performing a number of missions with associated mean mission time (MMT), mean down time (MDT) (including an average required delay), total direct cost, utilization percentage, total spending and TEC per mission, as shown in Tables 3 and 4, respectively.

TABLE 3
O1B1 Planning Technique

| | Orbiter 1 | Booster 1 | Orbiter 2 | Booster 2 | System |
|---|---|---|---|---|---|
| Missions | 9.7 | 10.0 | 5.0 | 5.0 | 14.7 |
| MMT | 10.0 | 10.0 | 10.0 | 10.0 | 10.0 |
| MDT | 27.6 | 35.5 | 63.0 | 72.0 | 39.7 |
| Total | 38,757 | 28,967 | 19,653 | 15,033 | $102,410 |
| Direct | | | | | |
| Cost | | | | | |
| Utilization | | | | | 49.75% |
| Total | | | | | $205,849 |
| Spending | | | | | |
| TEC per | $15,035 | $13,180 | $28,694 | $24,655 | $34,596 |
| Mission | | | | | |

TABLE 4
NINO Planning Technique

| | Orbiter 1 | Booster 1 | Orbiter 2 | Booster 2 | System |
|---|---|---|---|---|---|
| Missions | 9.0 | 9.0 | 9.0 | 9.0 | 18.0 |
| MMT | 10.0 | 10.0 | 10.0 | 10.0 | 10.0 |
| MDT | 30.6 | 39.6 | 30.6 | 39.6 | 30.6 |
| Total | $37,007 | $28,097 | $34,936 | $26,246 | $126,286 |
| Direct | | | | | |
| Cost | | | | | |
| Utilization | | | | | 57.48% |
| Total | | | | | $219,703 |
| Spending | | | | | |
| TEC per | $16,676 | $15,471 | $15,743 | $14,452 | $28,453 |
| Mission | | | | | |

In this example, it can be shown that the tasks required to turn a vehicle are unchanged. However, the delay time, which affects the MDT, is affected by the prioritization of the elements upon which the tasks are performed. Clearly, the O1B1 technique results in a significantly higher delay time for orbiter/booster 2, as compared to orbiter/booster 1. This results in a greater overall average delay time of 12.2 days, and fewer missions flown, as compared to the NINO technique. As shown above, at the system level, both scenarios result in the same fixed expenditure (i.e., $144,174). But total spending is higher to implement the NINO technique because of higher material consumption, as determined by multiplying the variable mission cost (i.e., $4,198) by the number of missions.

Analyzing the two planning techniques, the TEC per mission for the elements in each technique can provide a good indicator for selecting the lowest ownership cost alternative. The O1B1 planning technique provides the lowest TEC for the first set of elements (i.e., orbiter/booster 1). However, the NINO planning technique is clearly the optimal planning technique, as compared to the O1B1 technique since it results in a lower system TEC per mission. And even if more missions were not desired, demand could be met in fewer operating days by implementing the NINO planning technique.

Accepting the NINO planning technique as the optimal technique, consider an unplanned failure of the reaction control system (RCS) on orbiter 1. Also, assume that the failure occurs on the 35th calendar day with four days remaining in the 20 day orbiter processing cycle. The next missions, as scheduled, are expected to occur on the 47th day for orbiter 1, and on the 67th day for orbiter 2. Upon recognizing the failure, the unplanned maintenance and the schedule risk can be assessed for orbiter 1, where the unplanned repair tasks and their associated rates, durations, costs and resources can be shown in Table 5.

TABLE 5
RCS Repair Task Costs

| Task | Cost | Duration | Rate | Required Resource |
|---|---|---|---|---|
| Remove RCS | $50 | 2 | $25 | Orbiter Maintenance Resource |
| Repair RCS | $250 | 10 | $25 | Orbiter Maintenance Resource |
| Install RCS | $50 | 2 | $25 | Orbiter Maintenance Resource |

The dynamic resource management process can then evaluate the insertion of the RCS repair tasks in the orbiter 1 processing task while projecting the expected availability to the 61 st day, provided availability of the orbiter maintenance resource. The hierarchical dynamic resource management process can be further applied to alert a higher level of the organization of a schedule slip, and request use of orbiter maintenance resource for 14 additional days (total duration to complete the RCS repair tasks). A higher-level dynamic resource management process can then evaluate a number of different repair alternatives. For example, the RCS of orbiter 1 can be immediately repaired (the “repair” alternative). Alternatively, the maintenance priority can be changed to prepare orbiter/booster 2 for launch, with orbiter 1 thereafter repaired (the “switch” alternative). In yet another alternative, the RCS from orbiter 2 can be cannibalized to prepare orbiter 1 for launch, with the failed RCS thereafter repaired and installed in orbiter 2 during its processing task (the “cannibalize” alternative).

The planner/manager responsible for Orbiter 1 is interested in cannibalizing the RCS from orbiter 2. This results in a 6-day delay in generating the next mission for orbiter 1, and shifting the repair cost into the processing task of orbiter 2. Clearly, this alternative is unfavorable to the planner/manager of orbiter 2. In this regard, the best option for orbiter 2 is to gain immediate priority of the orbiter maintenance resource, in accordance with the switch alternative. This would allow orbiter 2 to begin its mission early, and have the least impact on the TEC of orbiter 2. In the dynamic resource management hierarchical process, task responsibility and resource allocation is elevated to a higher level. Overall, then, the recovery alternatives can be evaluated against the NINO planning technique base and each other based upon the delay to the mission of the respective system element and its impact on the TEC of the respective system element, as shown in Table 6 below.

TABLE 6
Orbiter 1 Repair Alternatives

| | Orbiter 1 | | Orbiter 2 | | System | |
|---|---|---|---|---|---|---|
| | Late- | | Late- | | Late- | |
| Alternative | ness | TEC | ness | TEC | ness | TEC |
| NINO Base | 0 | $16,676 | 0 | $15,743 | 0 | $28,453 |
| Repair | −14 | $17,018 | −14 | $16,982 | −28 | $29,449 |
| Switch | −34 | $18,844 | 4 | $15,941 | −30 | $30,161 |
| Cannibalize | −6 | $16,320 | −16 | $18,079 | −22 | $29,597 |

Unless mission prioritization is significantly important to the system, the switch alternative can be quickly rejected as it has the highest associated TEC. The repair alternative has the lowest TEC because the unnecessary remove and install tasks inherent in the cannibalization alternative are avoided. However, the difference in the TEC between the repair and cannibalize alternatives is not significant because of the overall earlier availability of orbiter 1 in the cannibalization alternative. Therefore, the dynamic resource management process can facilitate the system manager in choosing between the repair and cannibalize alternatives, such as based on a relative weighted importance of achieving lower cost or greater availability.

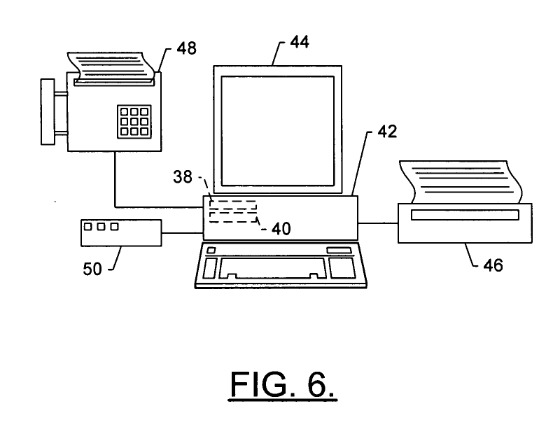

In accordance with embodiments of the present invention, a system for total effective cost management can include an organizing processing element at each level of the hierarchical organization 10. Although each level can include an organizing processing element, in some embodiments, one or more organizing processing elements may support more than one level of the hierarchical organization. As shown in FIG. 6, each organizing processing element 38 can be coupled to an associated memory device 40, both of which are commonly comprised by a computer system 42 or the like. In this regard, as indicated above, the method of embodiments of the present invention can be performed by the processing element manipulating data stored by the memory device with any of a number of different computer software, firmware and/or hardware. The computer system can include a display 44 for presenting information relative to performing embodiments of the method of the present invention, including the various maintenance plans as determined and selected according to embodiments of the present invention. To plot information relative to performing embodiments of the method of the present invention, the computer system can further include a printer 46.

Also, the computer system 42 can include a means for locally or remotely transferring the information relative to performing embodiments of the method of the present invention. For example, the computer system can include a facsimile machine 48 for transmitting information to other facsimile machines, computers or the like. Additionally, or alternatively, the computer can include a modem 50 to transfer information to other computers or the like. Further, the computer system can include an interface (not shown) to a network, such as a local area network (LAN), and/or a wide area network (WAN). For example, the computer system can include an Ethernet Personal Computer Memory Card International Association (PCMCIA) card configured to transmit and receive information to and from a LAN, WAN or the like.

In various advantageous embodiments, portions of the system and method of the present invention include a computer program product. The computer program product includes a computer-readable storage medium, such as the non-volatile storage medium (e.g., memory device 40), and computer-readable program code portions, such as a series of computer instructions, embodied in the computer-readable storage medium. Typically, the computer program is stored and executed by a processing unit or a related memory device, such as the organizing processing element 38 as depicted in FIG. 6.

In this regard, FIGS. 1, 2, 3, 4, 5A, 5B and 5C are block diagram, flowchart and control flow illustrations of methods, systems and program products according to the invention. It will be understood that each block or step of the block diagram, flowchart and control flow illustrations, and combinations of blocks in the block diagram, flowchart and control flow illustrations, can be implemented by computer program instructions. These computer program instructions may be loaded onto a computer or other programmable apparatus to produce a machine, such that the instructions which execute on the computer or other programmable apparatus create means for implementing the functions specified in the block diagram, flowchart or control flow block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the block diagram, flowchart or control flow block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block diagram, flowchart or control flow block(s) or step(s).

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagram, flowchart or control flow illustrations, and combinations of blocks or steps in the block diagram, flowchart or control flow illustrations, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for total effective cost management in an organization, the system comprising:
a processing element capable of creating a maintenance plan for the organization, the maintenance plan including at least one task performed during maintenance of the organization, wherein the processing element is also capable of creating a plurality of different maintenance schedules for performing the at least one task of the maintenance plan, wherein the processing element is capable of determining a total effective cost (TEC) associated with each maintenance schedule based upon a cost and an availability associated with the maintenance schedule, the availability being based upon a down time and a mission time associated with the maintenance schedule, and wherein the processing element is capable of at least one of selecting and receiving a selection of a maintenance schedule from the plurality of different maintenance schedules based upon the TEC for each maintenance schedule.

2. A system according to claim 1, wherein the processing element is capable of creating a maintenance plan including at least one task having an associated time duration expected to complete the respective task, and wherein the processing element is further capable of determining the down time associated with each of the plurality of different maintenance schedules based upon a time duration expected to complete at least one task of the maintenance plan.

3. A system according to claim 1, wherein the processing element is capable of creating a maintenance plan including at least one task having an associated cost expected to be incurred in performing the respective task, and wherein the processing element is further capable of determining the cost associated with each of the plurality of different maintenance schedules based upon a cost expected to be incurred in performing at least one task of the maintenance plan.

4. A system according to claim 1, wherein the processing element is capable of determining the TEC for each maintenance schedule in accordance with the following:
$$TEC = Cost \times ( 1 + \frac{MDT}{MMT} ) , and$$
wherein Cost represents a cost associated with the maintenance schedule, and MDT and MMT represent a down time and mission time, respectively, associated with the maintenance schedule.

5. A system according to claim 1, wherein the processing element is capable of at least one of selecting and receiving a selection of the maintenance schedule associated with the lowest TEC.

6. A system according to claim 1, wherein the organization comprises a hierarchical organization including n levels L₁ . . . Lₙ with n being a positive integer, wherein for at least i>1 each level Lᵢ comprises a plurality of components, and wherein the components of level Lᵢ₋₁ comprise groupings of the components of level Lᵢ, and
wherein the processing element is capable of creating a maintenance plan, creating a plurality of different maintenance schedules, determining a TEC associated with each maintenance schedule and at least one of selecting and receiving a selection of a maintenance schedule for at least one component of at least one level of the organization.

7. A system according to claim 6, wherein the processing element is capable of determining a down time associated with each of the plurality of different maintenance schedules of at least one component of at least one level based upon a time duration expected to complete at least one task of the maintenance plan of the respective component of the respective level, and wherein the processing element is capable of determining a cost associated with each of the plurality of different maintenance schedules of at least one component of at least one level based upon a cost expected to be incurred in performing at least one task of the maintenance plan of the respective component of the respective level.

8. A system according to claim 7, wherein the processing element is capable of determining, for at least level Lᵢ₊₁, a down time and a cost associated with each of the plurality of different maintenance schedules of at least one component of level Lᵢ₊₁ based upon the down time and cost associated with at least one component of level Lᵢ grouped to form the component of level Lᵢ₊₁.

9. A method of total effective cost management in an organization, the method comprising:
creating a maintenance plan for the organization, the maintenance plan including at least one task performed during maintenance of the organization;
creating a plurality of different maintenance schedules for performing the at least one task of the maintenance plan;
determining a total effective cost (TEC) associated with each maintenance schedule based upon a cost and an availability associated with the maintenance schedule, the availability being based upon a down time and a mission time associated with the maintenance schedule; and
selecting a maintenance schedule from the plurality of different maintenance schedules based upon the TEC for each maintenance schedule.

10. A method according to claim 9, wherein creating a maintenance plan comprises creating a maintenance plan including at least one task having an associated time duration expected to complete the respective task, and wherein the method further comprises:
determining a down time associated with each of the plurality of different maintenance schedules based upon a time duration expected to complete at least one task of the maintenance plan.

11. A method according to claim 9, wherein creating a maintenance plan comprises creating a maintenance plan including at least one task having an associated cost expected to be incurred in performing the respective task, and wherein the method further comprises:
determining a cost associated with each of the plurality of different maintenance schedules based upon a cost expected to be incurred in performing at least one task of the maintenance plan.

12. A method according to claim 9, wherein determining a TEC associated with each maintenance schedule comprises determining the TEC for each maintenance schedule in accordance with the following:
$$TEC = Cost \times ( 1 + \frac{MDT}{MMT} ) , and$$
wherein Cost represents a cost associated with the maintenance schedule, and MDT and MMT represent a down time and mission time, respectively, associated with the maintenance schedule.

13. A method according to claim 9, wherein selecting a maintenance schedule comprises selecting the maintenance schedule associated with the lowest TEC.

14. A method according to claim 9, wherein the organization comprises a hierarchical organization including n levels L₁ . . . Lₙ with n being a positive integer, wherein for at least i>1 each level Lᵢ comprises a plurality of components, and wherein the components of level Lᵢ₋₁ comprise groupings of the components of level Lᵢ, and
wherein creating a maintenance plan, creating a plurality of different maintenance schedules, determining a TEC associated with each maintenance schedule and selecting a maintenance schedule occur for at least one component of at least one level of the organization.

15. A method according to claim 14 further comprising:
determining a down time associated with each of the plurality of different maintenance schedules of at least one component of at least one level based upon a time duration expected to complete at least one task of the maintenance plan of the respective component of the respective level; and
determining a cost associated with each of the plurality of different maintenance schedules of at least one component of at least one level based upon a cost expected to be incurred in performing at least one task of the maintenance plan of the respective component of the respective level.

16. A method according to claim 15, wherein determining a down time and a cost associated with each of the plurality of different maintenance schedules of at least one component of at least one level comprises determining, for at least level Lᵢ₊₁, a down time and a cost associated with each of the plurality of different maintenance schedules of at least one component of level Lᵢ₊₁ based upon the down time and cost associated with at least one component of level Lᵢ grouped to form the component of level Lᵢ₊₁.

17. A computer program product for total effective cost management in an organization, the computer program product comprising at least one computer-readable storage medium having computer-readable program code embodied in said medium, the computer-readable program code comprising:
a first executable portion for creating a maintenance plan for the organization, the maintenance plan including at least one task performed during maintenance of the organization;
a second executable portion for creating a plurality of different maintenance schedules for performing the at least one task of the maintenance plan;
a third executable portion for determining a total effective cost (TEC) associated with each maintenance schedule based upon a cost and an availability associated with the maintenance schedule, the availability being based upon a down time and a mission time associated with the maintenance schedule; and
a fourth executable portion for at least one of selecting and receiving a selection of a maintenance schedule from the plurality of different maintenance schedules based upon the TEC for each maintenance schedule.

18. A computer program product according to claim 17, wherein the first executable portion is adapted to create a maintenance plan including at least one task having an associated time duration expected to complete the respective task, and wherein the computer program product further comprises:
a fifth executable portion for determining a down time associated with each of the plurality of different maintenance schedules based upon a time duration expected to complete at least one task of the maintenance plan.

19. A computer program product according to claim 17, wherein the first executable portion is adapted to create a maintenance plan including at least one task having an associated cost expected to be incurred in performing the respective task, and wherein the computer program product further comprises:
a fifth executable portion for determining a cost associated with each of the plurality of different maintenance schedules based upon a cost expected to be incurred in performing at least one task of the maintenance plan.

20. A computer program product according to claim 17, wherein the third executable portion is adapted to determine the TEC for each maintenance schedule in accordance with the following:
$$TEC = Cost \times ( 1 + \frac{MDT}{MMT} ) , and$$
wherein Cost represents a cost associated with the maintenance schedule, and MDT and MMT represent a down time and mission time, respectively, associated with the maintenance schedule.

21. A computer program product according to claim 17, wherein the fourth executable portion is adapted to at least one of select and receive a selection of the maintenance schedule associated with the lowest TEC.

22. A computer program product according to claim 17, wherein the organization comprises a hierarchical organization including n levels L₁ . . . Lₙ with n being a positive integer, wherein for at least i>1 each level Lᵢ comprises a plurality of components, and wherein the components of level Lᵢ₋₁ comprise groupings of the components of level Lᵢ, and
wherein the first executable portion is adapted to create a maintenance plan, the second executable portion is adapted to create a plurality of different maintenance schedules, the third executable portion is adapted to determine a TEC associated with each maintenance schedule and the fourth executable portion is adapted to at least one of select and receive a selection of a maintenance schedule for at least one component of at least one level of the organization.

23. A computer program product according to claim 22 further comprising:
a fifth executable portion for determining a down time associated with each of the plurality of different maintenance schedules of at least one component of at least one level based upon a time duration expected to complete at least one task of the maintenance plan of the respective component of the respective level; and
a sixth executable portion for determining a cost associated with each of the plurality of different maintenance schedules of at least one component of at least one level based upon a cost expected to be incurred in performing at least one task of the maintenance plan of the respective component of the respective level.

24. A computer program product according to claim 23, wherein the fifth and sixth executable portions are adapted to determine, for at least level Lᵢ₊₁, a down time and a cost associated with each of the plurality of different maintenance schedules of at least one component of level Lᵢ₊₁ based upon the down time and cost associated with at least one component of level Lᵢ grouped to form the component of level Lᵢ₊₁.
